(19) United States
(12) Patent Application Publication
(10) Pub. No.: US 2021/0132352 A1
(43) Pub. Date: May 6, 2021

(54) OPTICAL DEFLECTOR AND SCANNING LASER MICROSCOPE

(71) Applicant: OLYMPUS CORPORATION, Tokyo (JP)

(72) Inventor: Naoki SHIRAISHI, Tokyo (JP)

(73) Assignee: OLYMPUS CORPORATION, Tokyo (JP)

(21) Appl. No.: 17/118,832

(22) Filed: Dec. 11, 2020

Related U.S. Application Data
(63) Continuation of application No. PCT/JP2018/022799, filed on Jun. 14, 2018.

(51) Int. Cl. G02B 21/00; G02B 26/08; G02B 7/182; G02B 26/10

(52) U.S. Cl. CPC G02B 21/0048; G02B 26/101; G02B 7/1821; G02B 26/0816

(57) ABSTRACT

An optical deflector includes: a movable unit including a mirror having an optical reflection surface and a first rib formed on a back surface of the optical reflection surface, and a mirror holder configured to hold the mirror unit and having a second rib arranged in a direction intersecting the first rib and joined to the first rib at an intersection with the first rib; a pair of elastic members provided on both sides of the movable unit and configured to support the movable unit so as to be swingable about a swing axis; and a pair of supports connected to the elastic members and configured to support the elastic members, wherein the first rib includes a pair of first protrusions, and the second rib includes a pair of second protrusions.

This application is a continuation of International Application No. PCT/JP2018/022799, filed on Jun. 14, 2018, the entire contents of which are incorporated herein by reference.

### BACKGROUND

The present disclosure relates to an optical deflector and a scanning laser microscope.

In the related art, there is a widely used scanning laser microscope which scans a sample while irradiating the sample with laser light being excitation light and acquires a fluorescence image emitted from the sample. In recent years, there is a device applied as an optical deflector used for such a scanning laser microscope or the like, which uses a torsion beam to support a movable unit having a reflection surface from both sides and swings the movable unit using the torsion beam as an axis to perform scanning of the reflected light, including a rib formed on the back surface of the reflection surface of the movable unit and having a stress relaxation region provided between the end of the reflection surface and the torsion beam (refer to Japanese Patent No. 5857602).

### SUMMARY

According to one aspect of the present disclosure, there is provided an optical deflector including: a movable unit including a mirror having an optical reflection surface and a first rib formed on a back surface of the optical reflection surface, and a mirror holder configured to hold the mirror unit and having a second rib arranged in a direction intersecting the first rib and joined to the first rib at an intersection with the first rib; a pair of elastic members provided on both sides of the movable unit and configured to support the movable unit so as to be swingable about a swing axis; and a pair of supports connected to the elastic members and configured to support the elastic members, wherein the first rib includes a pair of first protrusions, and the second rib includes a pair of second protrusions.

The above and other features, advantages and technical and industrial significance of this disclosure will be better understood by reading the following detailed description of an embodiment of the disclosure, when considered in connection with the accompanying drawings.

### BRIEF DESCRIPTION OF THE DRAWINGS

FIG. 1 is a diagram illustrating a configuration of a scanning laser microscope according to an embodiment;

FIG. 2 is a perspective view schematically illustrating a configuration of an optical deflector used in the scanning laser microscope of FIG. 1;

FIG. 3 is an exploded perspective view of a movable unit in the optical deflector illustrated in FIG. 2;

FIG. 4 is an enlarged perspective view schematically illustrating a joint between the first rib and the second rib having no protrusion;

FIG. 5 is an enlarged perspective view schematically illustrating a joint between the first rib and the second rib of the optical deflector illustrated in FIG. 2;

FIG. 6 is a perspective view schematically illustrating the shape of a protrusion according to a first modification of the embodiment;

FIG. 7 is a perspective view schematically illustrating the shape of a protrusion according to a second modification of the embodiment;

FIG. 8 is a plan view schematically illustrating a joint between the first rib and the second rib in FIG. 7;

FIG. 9 is a perspective view schematically illustrating a back surface of a mirror unit of an optical deflector according to a third modification of the embodiment;

FIG. 10 is a perspective view schematically illustrating a holding surface of a mirror holder of an optical deflector according to the third modification of the embodiment;

FIG. 11 is a perspective view schematically illustrating a back surface of a mirror unit of an optical deflector according to a fourth modification of the embodiment; and

FIG. 12 is a perspective view schematically illustrating a holding surface of a mirror holder of the optical deflector according to the fourth modification of the embodiment.

### DETAILED DESCRIPTION

Hereinafter, a scanning laser microscope including an optical deflector will be described as a mode for carrying out the present disclosure (hereinafter referred to as an “embodiment”). In addition, the present disclosure is not limited by the embodiment. Furthermore, each of drawings referred to in the following description is merely an example schematically illustrating shapes, size, and positional relationships to the degree that makes the present disclosure understandable. That is, the present disclosure is not limited only to the shapes, the size and the positional relationships illustrated in each of the drawings. Furthermore, dimensions and ratios can be mutually different in individual drawings.

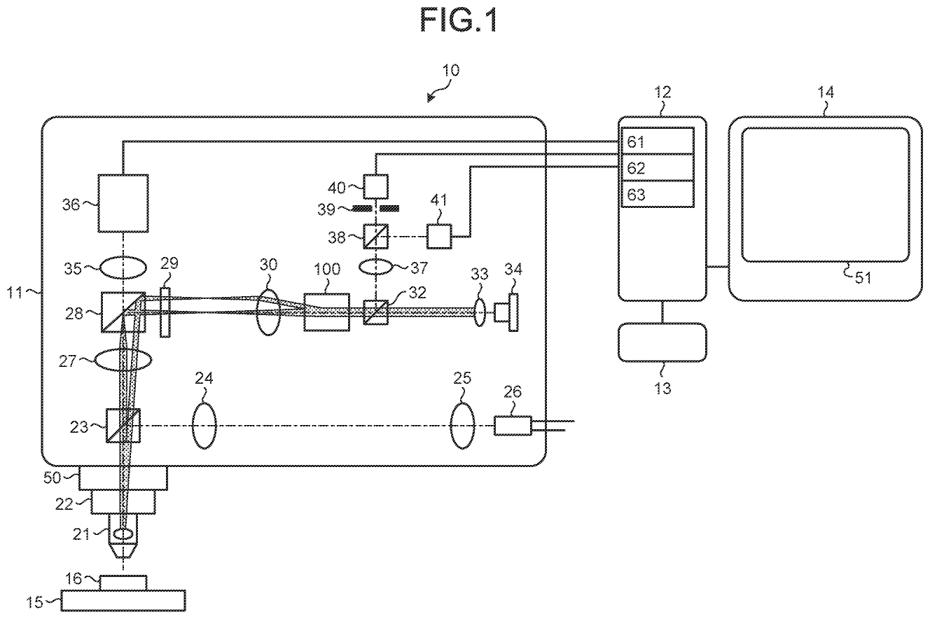

FIG. 1 illustrates a configuration of a scanning laser microscope 10 according to an embodiment. The scanning laser microscope 10 includes a microscope body 11, a controller 12, an input device 13, a display device 14, and a sample table 15.

The microscope body 11 includes: an objective lens 21; a revolver 22; beam splitters 23, 28 and 38; an illumination lens 24; a collector lens 25; a white light source 26; a tube lens 27; a quarter-wave plate 29; illumination optics 30; an optical deflector 100; a polarization beam splitter 32; condenser lenses 33 and 37; a laser light source 34; a video camera lens 35; a video image acquisition charge coupled device (CCD) camera 36; a pinhole 39; a confocal image acquisition detector 40; a non-confocal image acquisition detector 41; and a Z movement mechanism 50. In the present disclosure, a photomultiplier may be used as the confocal image acquisition detector 40 and the non-confocal image acquisition detector 41. Moreover, a white illumination fiber light source may be used as the white light source 26.

When acquiring a confocal image and a non-confocal image, the laser light (illumination light) emitted from the laser light source 34 is guided to pass through an optical path including: the condenser lens 33; the polarization beam splitter 32; the optical deflector 100; the illumination optics 30; the quarter-wave plate 29; the beam splitter 28; the tube lens 27; the beam splitter 23; and the objective lens 21, so as to be focused and applied onto a sample 16 mounted on the sample table 15, as spotlight. Here, when two-dimensionally scanning of the illumination light is performed by the optical deflector 100, the scanning of the spotlight is performed on the sample 16 in the X-Y directions, that is, two directions orthogonal to each other on a plane perpendicular to the direction (Z direction) of the optical axis of the objective lens 21. At this time, the reflected light from the sample 16 passes through the optical path from the objective lens 21 to the polarization beam splitter 32 in the opposite direction so as to be guided by the polarization beam splitter 32 toward the condenser lens 37. Subsequently, the reflected light that has passed through the condenser lens 37 is split into two beams of light by the beam splitter 38, one of which is incident on the confocal image acquisition detector 40 via the pinhole 39, while the other is incident on the non-confocal image acquisition detector 41.

When acquiring a color video image, the illumination light emitted from the white light source 26 is guided to pass through an optical path including the collector lens 25, the illumination lens 24, the beam splitter 23, and the objective lens 21 so as to illuminate the sample 16. At this time, the reflected light from the sample 16 passes through the objective lens 21, the beam splitter 23, the tube lens 27, the beam splitter 28, and the video camera lens 35 so as to be incident on the video image acquisition CCD camera 36.

In the confocal optical system including the confocal image acquisition detector 40 and the non-confocal image acquisition detector 41, a confocal system in which the pinhole 39 is inserted and a non-confocal system without the pinhole 39 are arranged to simultaneously detect the reflected light after passing through the beam splitter 38. Subsequently, output signals from the confocal image acquisition detector 40 and the non-confocal image acquisition detector 41 are transmitted to the controller 12 as an LSM output signal as a two-channel signal.

The video optical system including the video image acquisition CCD camera 36 is used for acquisition of a video image of the sample 16 illuminated with the illumination light from the white light source 26. Subsequently, the signal representing the video image as a video output signal is transmitted from the video image acquisition CCD camera 36 to the controller 12.

The controller 12 includes: an arithmetic unit 61; a control unit 62; and a storage unit 63. An example of the controller 12 is an information processing device such as a personal computer. Here, the arithmetic unit 61 includes: a micro-processing unit (MPU); and memory devices including a read only memory (ROM) and a random access memory (RAM).

The ROM stores a predetermined basic control program beforehand. The MPU reads and executes this basic control program when the arithmetic unit 61 is started up, thereby enabling operation control of individual components of the arithmetic unit 61. Furthermore, the RAM is used as a work storage area as needed when the MPU executes various control programs.

The arithmetic unit 61 controls the scanning laser microscope 10 illustrated in FIG. 1, such as the video image acquisition CCD camera 36, the confocal image acquisition detector 40, the non-confocal image acquisition detector 41, the optical deflector 100, the laser light source 34, or the like, via the control unit 62. In addition, the arithmetic unit 61 performs various types of control process such as a storage control process for storing the confocal image and the video image acquired by the microscope body 11 in the storage unit 63 and display control process for displaying these images being stored in the storage unit 63.

Examples of the input device 13 include a keyboard device, a pointing device such as a mouse device, and a touch panel. The input device 13 provides a graphical user interface (GUI) in cooperation with the operation screen displayed on a monitor screen 51 of the display device 14, acquires the input of instruction or information by the user of the scanning laser microscope 10 in FIG. 1 using the GUI, and transfers the acquired input to the controller 12.

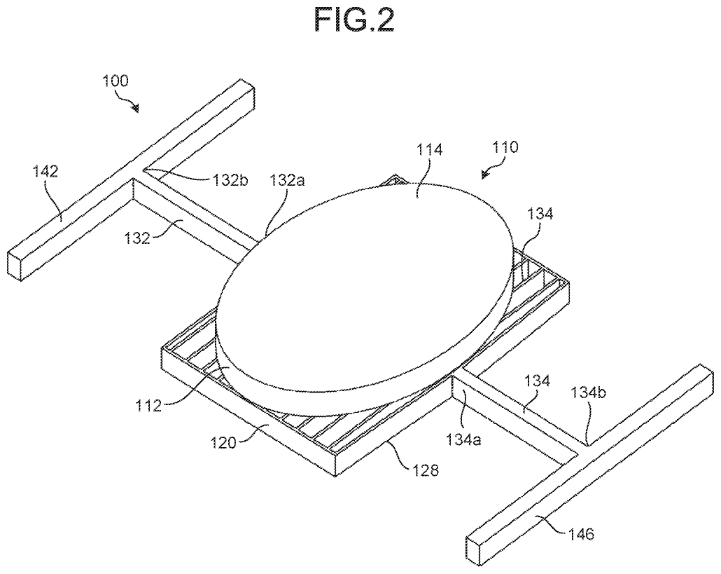

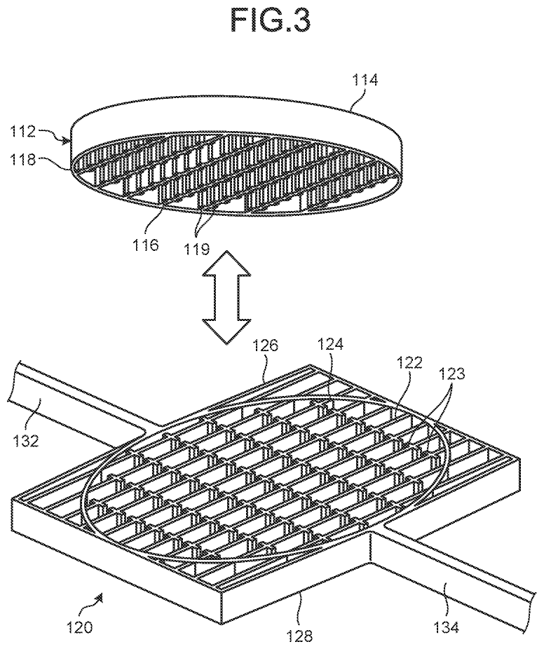

Next, the optical deflector 100 used in the scanning laser microscope 10 will be described. FIG. 2 is a perspective view schematically illustrating a configuration of the optical deflector 100 used in the scanning laser microscope 10 of FIG. 1. FIG. 3 is an exploded perspective view of a movable unit of the optical deflector 100 of FIG.

As illustrated in FIG. 2, the optical deflector 100 at least includes: a movable unit 110 having an optical reflection surface 114; elastic members 132 and 134 that support the movable unit 110 to be swingable about a swing axis; and supports 142 and 146 that support the elastic members 132 and 134, respectively.

The elastic members 132 and 134 provided as a pair and having rectangular cross sections symmetrically extend from the movable unit 110 to both sides. The elastic members 132 and 134 have first ends 132a and 134a and second ends 132b and 134b, respectively. The first ends 132a and 134a are each connected to a mirror holder 120 of the movable unit 110. The second ends 132b and 134b are connected to the supports 142 and 146, respectively. The movable unit 110 is supported by the supports 142 and 146 so as to be swingable about a swing axis that passes through the inside of the elastic members 132 and 134.

The movable unit 110 has a mirror unit 112 having an optical reflection surface 114 and a mirror holder 120 having a driving force generation surface 128. The mirror unit 112 and the mirror holder 120 are joined with each other so that the optical reflection surface 114 and the driving force generation surface 128 are arranged on the outer sides on the opposite sides. It is preferable that both the optical reflection surface 114 and the driving force generation surface 128 have high flatness.

The side surface of the mirror unit 112 is orthogonal to the optical reflection surface 114, while the side surface of the mirror holder 120 is orthogonal to the driving force generation surface 128. The optical reflection surface 114 has a smaller area than the driving force generation surface 128.

The driving force generation surface 128 of the mirror holder 120 is provided with a driving force generating member that swings the movable unit 110. Various types of driving force generating members are used depending on the driving method of the optical deflector 100. For example, in the electromagnetic driving method, the driving force generating member is a driving coil that circulates around the edge of the movable unit 110. In the electrostatic driving method, the driving force generating member is a pair of driving electrodes formed over substantially the entire surface of the movable unit 110. The movable unit 110 swings about the swing axis by the driving force generating member provided on the driving force generation surface 128. The light incident on the optical reflection surface 114 is operated by this swing.

The driving force generation surface 128 has a rectangular contour, and the optical reflection surface 114 has an elliptical contour. For example, the driving force generation surface 128 is elongated in the direction orthogonal to the swing axis, while the optical reflection surface 114 has its major axis in the direction orthogonal to the swing axis. As illustrated in FIG. 2, the elliptical shape of the optical reflection surface 114 preferably has a contour that is substantially inscribed in the rectangle of the driving force generation surface 128, but the shape is not limited to this.

In order to prevent concentration of stress, a roundness (R) is given to the connecting portion between the elastic members 132 and 134 and the mirror holder 120 and the connecting portion between the elastic members 132 and 134 and the supporting portions 142 and 146.

The optical deflector 100 is formed of a single crystal silicon substrate using a semiconductor process, for example. Single crystal silicon has high rigidity and little internal damping of the material and thus is suitable as the material of the elastic members 132 and 134 for resonance driving as well as suitable as the material of the supports 142 and 146 bonded to the external members.

As illustrated in FIG. 3, the mirror unit 112 has a first rib 116 formed on the back surface of the optical reflection surface 114. The first rib 116 protrudes from the back surface of the optical reflection surface 114 and extends in a direction parallel to the swing axis of the elastic members 132 and 134.

The mirror holder 120 is formed of the same layer as the elastic members 132 and 134. Furthermore, the mirror holder 120 has a driving force generation surface 128 and a second rib 122 formed on the back surface of the driving force generation surface 128, that is, a holding surface in contact with the first rib 116. The second rib 122 protrudes from the back surface of the driving force generation surface 128 and extends in the direction orthogonal to the swing axis of the elastic members 132 and 134.

The first rib 116 and the second rib 122 intersect each other in overpass crossing. In the present specification, the state in which the first rib 116 and the second rib 122 intersect each other in overpass crossing represents a state in which the first rib 116 is located above the second rib 122 to extend across the second rib 122 and the second rib 122 is located below the first rib 116 to extend across the first rib 116. The first rib 116 and the second rib 122 are joined with each other at their intersecting portions.

Furthermore, the mirror unit 112 is a solid having the contour shape of the elliptical optical reflection surface 114 as an end surface and includes a first frame 118 formed on an outer peripheral portion of the contour shape. Similar to the first rib 116, the first frame 118 protrudes from the back surface of the optical reflection surface 114.

The mirror holder 120 has a second frame 124 joined to the mirror unit 112. That is, the second frame 124 has the elliptical contour shape same as the first frame 118. The mirror holder 120 is a solid having a rectangular contour shape as an end surface, having a third frame 126 formed on the outer peripheral portion of the contour shape. The second frame 124 and the third frame 126 protrude from the back surface of the driving force generation surface 128, similarly to the second rib 122.

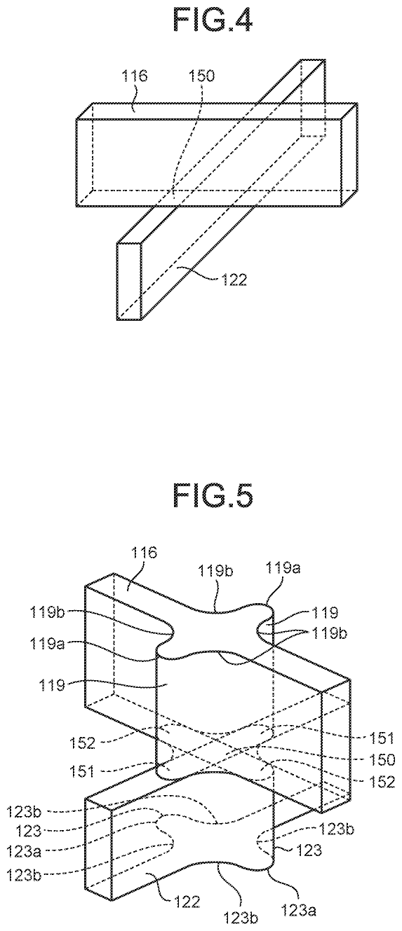

Furthermore, the first rib 116 has a pair of first protrusions 119 protruding in the extending direction of the second rib 122 from a joint 150 between the first rib 116 and the second rib 122 along the second rib 122. The second rib 122 has a pair of second protrusions 123 protruding in the extending direction of the first rib 116 from the joint 150 between the first rib 116 and the second rib 122 along the first rib 116. The pair of first protrusions 119 extends symmetrically with respect to the first rib 116, while the pair of second protrusions 123 extends symmetrically with respect to the second rib 122. FIG. 4 is an enlarged perspective view schematically illustrating the joint 150 between the first rib 116 and the second rib 122 having no protrusion. FIG. 5 is an enlarged perspective view schematically illustrating the joint 150 between the first rib 116 and the second rib 122 of the optical deflector 100 illustrated in FIG. 2.

As illustrated in FIG. 5, the first rib 116 has the pair of first protrusions 119 protruding in the extending direction of the second rib 122, while the second rib 122 has the pair of second protrusions 123 protruding in the extending direction of the first rib 116. In a case where the first rib 116 and the second rib 122 do not have the first protrusion 119 and the second protrusion 123 respectively, the connecting area between the first rib 116 and the second rib 122 would be only the area of the joint 150 at which the first rib 116 and the second rib 122 come in contact as illustrated in FIG. 4. In this case, the stress generated when the optical deflector 100 swings would be concentrated in the joint 150, leading to a possibility of fracture in the joint 150. In the embodiment, the first rib 116 is provided with the first protrusion 119 protruding from the joint 150 in the extending direction of the second rib 122, and the first protrusion 119 is joined with the second rib 122 to form a first joint 151. Furthermore, the second rib 122 has the second protrusion 123 protruding from the joint 150 in the extending direction of the first rib 116, and the second protrusion 123 is joined with the first rib 116 to form a second joint 152. In the embodiment, by forming the first protrusion 119 and the second protrusion 123, it is possible to obtain the joining area being a sum of the joint 150, the first joint 151, and the second joint 152, making it possible to increase the joining area. This enables suppression of the concentration of stress applied to the joint between the first rib 116 and the second rib 122, leading to prevention of fracture in the joint.

An apex 119a of the first protrusion 119 and an apex 123a of the second protrusion 123 each have a rounded corner. The stress generated during swinging concentrates on the corners and this causes occurrence of fracture from the corners. However, by forming the contours of the first protrusion 119 and the second protrusion 123 to have rounded corners, it is possible to disperse the stress generated in the contours of the first joint 151 and the second joint 152 in a curve, leading to prevention of fracture in the joint. In the present specification, the “rounded corner” generally represents a configuration of corners that have been rounded and referred to as corner R. That is, the rounded corner means a portion having an outer peripheral portion with a shape formed by a curve or a straight line smoothly connected without a singular point.

Furthermore, a connecting portion 119b between the first protrusion 119 and the first rib 116 and a connecting portion 123b between the second protrusion 123 and the second rib 122 each have a rounded corner. As described above, the stress generated at the time of swinging is concentrated on the corners and fracture occurs from the corners. Fortunately however, by forming the connecting portion between the first protrusion 119 and the first rib 116, and the connecting portion between the second protrusion 123 and the second rib 122 into the shapes with rounded corners, it is possible to disperse the stress generated between the connecting portion between the first protrusion 119 and the first rib 116, and connecting portion between the second protrusion 123 and the second rib 122, in a curve, leading to prevention of fracture in the joint.

In the embodiment, the first rib 116 and the second rib 122 each have the pair of first protrusions 119 and the pair of second protrusions 123, respectively. However, the present disclosure is not limited to this. For example, when the first rib 116 has at least one first protrusion 119, the second rib 122 has at least one second protrusion 123, or the first rib 116 has at least one first protrusion 119 and the second rib 122 has at least one second protrusion 123, it is possible to increase the area of the joint to suppress the concentration of stress applied to the joint, making it possible to obtain an effect of preventing fracture in the joint. Furthermore, even when the pair of the first protrusion 119 and the pair of the second protrusion 123 are individually provided, the pair of first protrusions 119 and the pair of second protrusions 123 do not necessarily have to be symmetrical.

Furthermore, in the embodiment, the mirror unit 112 and the mirror holder 120 are provided so that the first rib 116 and the second rib 122 face each other. This enables the back surface of the holding surface that holds the mirror unit 112 of the mirror holder 120 to be used as the driving force generation surface 128 that achieve high flatness and forms the driving force generating member. This makes it possible to miniaturize the optical deflector 100.

Furthermore, in the movable unit 110 of the optical deflector 100 according to the embodiment, the mirror unit 112 has the first rib 116 extending parallel to the swing axis of the elastic members 132 and 134, and the mirror holder 120 has the second rib 122 extending in a direction orthogonal to the swing axis of the elastic members 132 and 134. This configuration of the movable unit 110 can achieve a smaller strain due to inertial force in the movable unit and a higher rigidity against the inertial force as compared to a movable unit in which the mirror unit 112 and the mirror holder 120 include both of ribs extending parallel to the swing axis of the elastic members 132 and 134 and ribs extending in the direction orthogonal to the swing axis of the elastic members 132 and 134.

Furthermore, since the elastic members 132 and 134 are formed in the same layer as the mirror holder 120, it is possible to reduce the reaction force of the elastic members 132 and 134 transmitted to the optical reflection surface 114, as compared to the structure in which the elastic members 132 and 134 are formed on the mirror unit 112 having the optical reflection surface 114.

As described above, according to the optical deflector 100 of the embodiment, the movable unit 110 has a structure that adopts a configuration in which the first rib 116 is formed on the back surface of the optical reflection surface 114 of the mirror unit 112 and the second rib 122 is formed on the holding surface of the mirror holder 120, with the first rib 116 and the second rib 122 extending to intersect each other in overpass crossing. With this configuration, it is possible to suppress dynamic strain on the optical reflection surface 114 due to inertial force, and obtain flatness in both the optical reflection surface 114 of the movable unit 110 and the driving force generation surface 128, making it possible to miniaturize the optical deflector 100. Furthermore, by forming the elastic members 132 and 134 in the same layer as the mirror holder 120, it is possible to suppress the dynamic strain of the optical reflection surface 114 due to the reaction force of the elastic members 132 and 134. Furthermore, by forming the first protrusion 119 and the second protrusion 123 on the first rib 116 and the second rib 122, respectively, it is possible to prevent fracture in the joint.

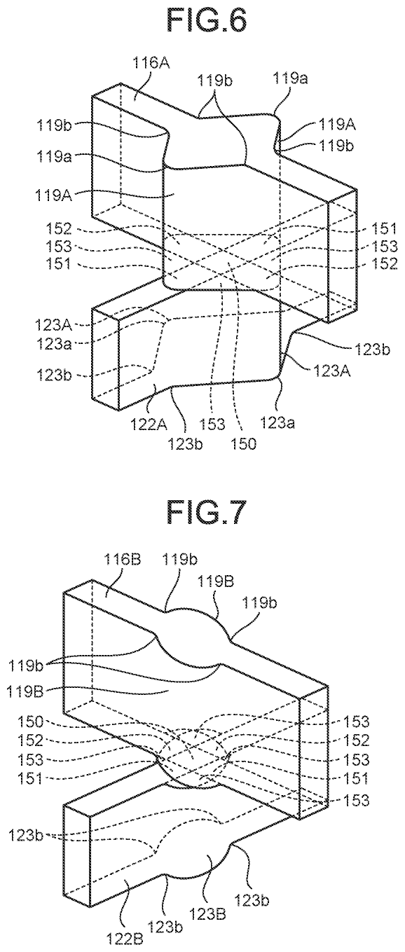

FIG. 6 is a perspective view schematically illustrating the shapes of a first protrusion 119A and a second protrusion 123A according to a first modification of the embodiment. The first protrusion 119A and a second protrusion 123A according to the first modification of the embodiment protrude beyond the widths of the second rib 122A and the first rib 116A.

The first rib 116A has a pair of the first protrusion 119A protruding beyond the width of the second rib 122A in the extending direction of the second rib 122A, from the joint 150 between the first rib 116A and the second rib 122A. The second rib 122A has the pair of second protrusion 123A protruding beyond the width of the first rib 116A in the extending direction of the first rib 116A, from the joint 150 between the first rib 116A and the second rib 122A. The first protrusion 119A and the second protrusion 123A each have a triangular shape. The pair of first protrusions 119A extends symmetrically with respect to the first rib 116A, while the pair of second protrusions 123A extends symmetrically with respect to the second rib 122A.

In the first modification of the embodiment, the first rib 116A has the first protrusion 119A protruding from the joint 150 in the extending direction of the second rib 122A, and the first protrusion 119A is joined with the second rib 122A to form the first joint 151. Furthermore, the second rib 122A has the second protrusion 123A protruding from the joint 150 in the extending direction of the first rib 116A, and the second protrusion 123A is joined with the first rib 116A to form the second joint 152. Furthermore, the first protrusion 119A is joined with the second protrusion 123A to form a third joint 153. In the first modification of the embodiment, by forming the first protrusion 119A and the second protrusion 123A, it is possible to obtain the joining area being a sum of the joint 150, the first joint 151, the second joint 152, and the third joint 153, making it possible to increase the joining area. This enables suppression of the concentration of stress applied to the joint between the first rib 116A and the second rib 122A, leading to prevent fracture in the joint.

Furthermore, since the apex 119a of the first protrusion 119A and the apex 123a of the second protrusion 123A have rounded corners individually, it is possible to disperse the stress occurring in the contour portion of the first joint 151 and the second joint 152 in a curve, leading to the prevention of fracture in the joint.

Furthermore, the connecting portion 119b between the first protrusion 119A and the first rib 116A, and the connecting portion 123b between the second protrusion 123A and the second rib 122A each have a rounded corner. Therefore, it is possible to disperse the stress generated in the connecting portion 119b between the first protrusion 119A and the first rib 116A and the connecting portion 123b between the second protrusion 123A and the second rib 122A in a curve, leading to prevention of the fracture in the joint.

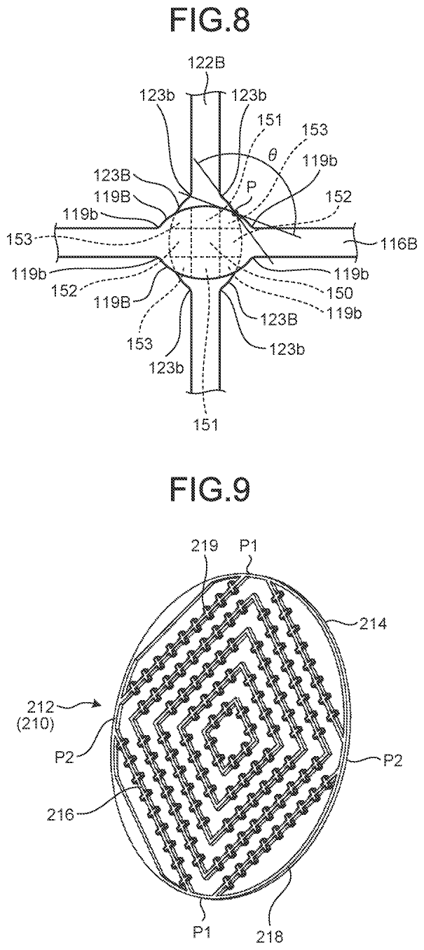

FIG. 7 is a perspective view schematically illustrating the shapes of a first protrusion 119B and a second protrusion 123B according to a second modification of the embodiment. FIG. 8 is a plan view schematically illustrating a joint between a first rib 116B and a second rib 122B illustrated in FIG. 7.

The first rib 116B according to the second modification of the embodiment has a configuration similar to the first modification, including a pair of the first protrusions 119B which protrudes beyond the width of the second rib 122B in the extending direction of the second rib 122B, while the second rib 122B includes a pair of the second protrusions 123B which protrudes beyond the width of the first rib 116B in the extending direction of the first rib 116B. The pair of first protrusions 119B extends symmetrically with respect to the first rib 116B, while the pair of second protrusions 123B extends symmetrically with respect to the second rib 122B. The joint 150 and the pair of first protrusions 119B have an elliptical shape as a whole, while the joint 150 and the pair of second protrusions 123B have an elliptical shape as a whole.

The first protrusion 119B and the second protrusion 123B have their contour lines intersect each other, without completely overlapping each other. When the first protrusion 119B and the second protrusion 123B have a shape in which contour lines intersect each other with no complete overlap of protrusions, an angle θ formed by the tangent line of the first protrusion 119B and the tangent line of the second protrusion 123B at an intersecting position P is preferably 900 or more, as illustrated in FIG. 8. By setting the angle θ formed by the tangent line of the first protrusion 119B and the tangent line of the second protrusion 123B at the position P to be 90° or more, the ratio of change in which the rigidity is discontinuous becomes gentle even when the contour lines intersect, making possible to easily escape the stress applied to the position P, leading to prevention of the concentration of the stress applied to the position P. In the present specification, the angle θ formed by the tangent line of the first protrusion 119B and the tangent line of the second protrusion 123B at the intersecting position P represents the angle externally formed by the first protrusion 119B and the second protrusion 123B.

Furthermore, similarly to the first modification, it is also possible, in the second modification of the embodiment, to obtain the joining area between the first rib 116B and the second rib 122B as the sum of the joint 150, the first joint 151, the second joint 152, and the third joint 153, making it possible to increase the joining area. This enables suppression of the concentration of stress applied to the joint between the first rib 116B and the second rib 122B, leading to the prevention of fracture in the joint.

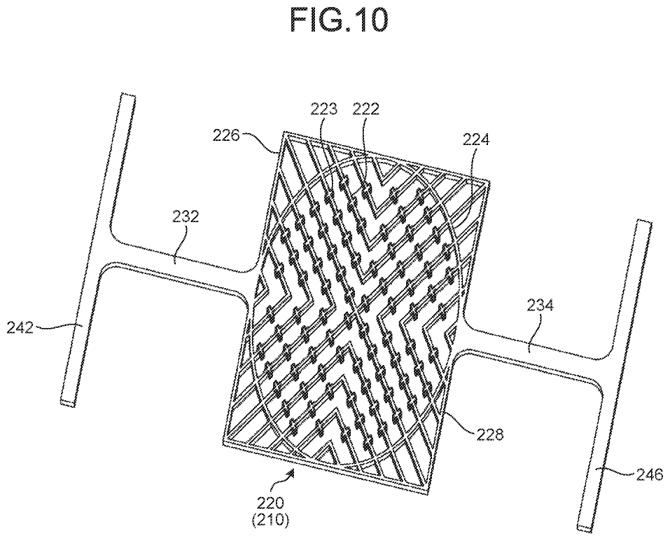

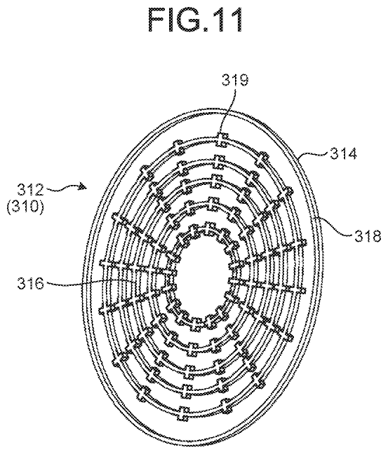

FIG. 9 is a perspective view schematically illustrating a back surface of a mirror unit 212 of an optical deflector according to a third modification of the embodiment. FIG. 10 is a perspective view schematically illustrating a holding surface of a mirror holder 220 of the optical deflector according to the third modification of the embodiment.

The optical deflector according to the third modification at least includes: a movable unit 210 having an optical reflection surface 214; elastic members 232 and 234 that support the movable unit 210 to be swingable about a swing axis; and supports 242 and 246 that support the elastic members 232 and 234, respectively. The movable unit 210 is formed of the mirror unit 212 and the mirror holder 220 that holds the mirror unit.

The mirror unit 212 has an optical reflection surface 214 having an elliptical contour and a first rib 216 formed on the back surface of the optical reflection surface 214. The first rib 216 protrudes from the back surface of the optical reflection surface 214, and extends in a direction parallel to the line connecting an intersection P1 between the outer circumference and the major axis of the elliptical optical reflection surface 214 and an intersection P2 of the outer circumference and the minor axis of the elliptical optical reflection surface 214.

The mirror holder 220 is formed of the same layer as the elastic members 232 and 234. Furthermore, the mirror holder 220 has a second rib 222 formed on the back surface of the driving force generation surface 128, that is, a holding surface in contact with the first rib 216. The second rib 222 protrudes from the back surface of a driving force generation surface 228 and extends in a direction parallel to a diagonal line of a rectangle circumscribing the elliptical optical reflection surface 214.

The first rib 216 and the second rib 222 intersect each other in overpass crossing, with a part of the first rib 216 and a part of the second rib 222 joined to each other.

The mirror unit 212 is a solid having the contour shape of the elliptical optical reflection surface 214 as an end surface and has a first frame 218 formed on the outer peripheral portion of the contour shape. Similarly to the first rib 216, the first frame 218 protrudes from the back surface of the optical reflection surface 214.

The mirror holder 220 has a second frame 224 joined to the first frame 218. That is, the second frame 224 has the same elliptical contour shape as the first frame 218. In addition, the mirror holder 220 is a solid having a rectangular contour shape as an end surface and has a third frame 226 formed on the outer peripheral portion of the contour shape. The second frame 224 and the third frame 226 protrude from the back surface of the driving force generation surface 228, similarly to the second rib 222.

Furthermore, the first rib 216 has a pair of first protrusions 219 protruding in the extending direction of the second rib 222 from a joint between the first rib 216 and the second rib 222 along the second rib 222. The second rib 222 has a pair of second protrusions 223 protruding in the extending direction of the first rib 216 from the joint between the first ribs 216 and the second rib 222 along the first rib 216. The pair of first protrusions 219 extends symmetrically with respect to the first rib 216, while the pair of second protrusions 223 extends symmetrically with respect to the second rib 222. By providing the first protrusion 219 and the second protrusion 223 respectively to the first rib 216 and the second rib 222 according to the third modification, it is possible to increase the joining area between the first rib 216 and the second rib 222 and suppress the concentration of stress applied to the joint between the first rib 216 and the second rib 222, enabling prevention of fracture in the joint.

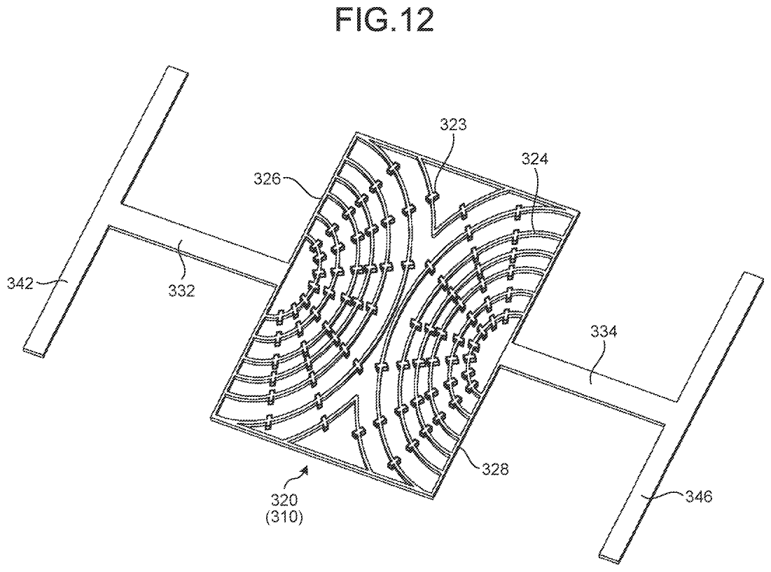

FIG. 11 is a perspective view schematically illustrating a back surface of a mirror unit 312 of an optical deflector according to a fourth modification of the embodiment. FIG. 12 is a perspective view schematically illustrating a holding surface of a mirror holder 320 of the optical deflector according to the fourth modification of the embodiment.

The optical deflector according to the fourth modification at least includes: a movable unit 310 having an optical reflection surface 314; elastic members 332 and 334 that support the movable unit 310 to be swingable about a swing axis; and supports 342 and 346 that support elastic members 332 and 334. The movable unit 310 is formed of the mirror unit 312 and the mirror holder 320.

The mirror unit 312 includes: an optical reflection surface 314 having an elliptical contour; and a first rib 316 formed on the back surface of the elliptical optical reflection surface 314. The first rib 316 extends along a plurality of ellipses arranged concentrically with respect to the center of the optical reflection surface 214, for example.

The mirror holder 320 is formed of the same layer as the elastic members 332 and 336. The mirror holder 320 has a driving force generation surface 328 and a second rib 322 formed on the back surface of the driving force generation surface 328. The second rib 322 extends in a curve. The curve may be, for example, a quadratic curve such as an ellipse, a parabola, or a hyperbola, but is not limited to these curves and may be another curve.

The first rib 316 and the second rib 322 extend so as to intersect each other in overpass crossing, with a part of the first rib 316 and a part of the second rib 322 joined to each other.

The mirror unit 312 is a solid having the contour shape of the elliptical optical reflection surface 314 as an end surface and has a first frame 318 formed on the outer peripheral portion of the contour shape. Similarly to the first rib 316, the first frame 318 protrudes from the back surface of the optical reflection surface 314.

The mirror holder 320 is a solid having a rectangular contour shape as an end surface, having a third frame 326 formed on the outer peripheral portion of the contour shape. The third frame 326 protrudes from the back surface of the driving force generation surface 328, similarly to the second rib 322.

Furthermore, the first rib 316 has a pair of first protrusions 319 protruding in the extending direction of the second rib 322 from a joint between the first rib 316 and the second rib 322 along the second rib 322. The second rib 322 has a pair of second protrusions 323 protruding in the extending direction of the first rib 316 from the joint between the first rib 316 and the second rib 322 along the first rib 316. The pair of first protrusions 319 extends symmetrically with respect to the first rib 316, while the pair of second protrusions 323 extends symmetrically with respect to the second rib 322. By providing the first protrusion 319 and the second protrusion 323 respectively to the first rib 316 and the second rib 322 according to the fourth modification, it is possible to increase the joining area between the first rib 316 and the second rib 322 and suppress the concentration of stress applied to the joint between the first rib 316 and the second rib 322, enabling prevention of fracture in the joint.

The optical deflector and the scanning laser microscope apparatus according to the present disclosure has a configuration in which the movable unit includes: a mirror unit having an optical reflection surface; and a mirror holder that holds the mirror unit, and in which the back surface of the light reflection surface of the mirror unit and the holding surface of the mirror holder are respectively provided with the first rib and the second rib so as to intersect each other, thereby suppressing the dynamic strain of the optical reflection surface, making it possible to provide a swing unit of a movable unit to the back surface of the holding surface of the mirror holder, leading to miniaturization of the optical deflector. Furthermore, by providing the first protrusion and the second protrusion in the first rib and the second rib respectively, it is possible to avoid concentration of stress generated in the joint and prevent fracture in the first rib and the second rib.

Additional advantages and modifications will readily occur to those skilled in the art. Therefore, the disclosure in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An optical deflector comprising:
a movable unit including
a mirror having an optical reflection surface and a first rib formed on a back surface of the optical reflection surface, and
a mirror holder configured to hold the mirror unit and having a second rib arranged in a direction intersecting the first rib and joined to the first rib at an intersection with the first rib;
a pair of elastic members provided on both sides of the movable unit and configured to support the movable unit so as to be swingable about a swing axis; and
a pair of supports connected to the elastic members and configured to support the elastic members,
wherein the first rib includes a pair of first protrusions, and the second rib includes a pair of second protrusions.

2. The optical deflector according to claim 1,
wherein an apex of at least one of the pair of first protrusions has a rounded corner, and an apex of at least one of the pair of second protrusions has a rounded corner.

3. The optical deflector according to claim 1,
wherein a connecting portion between one of the pair of first protrusions and the first rib has a rounded corner, and a connecting portion between one of the pair of second protrusions and the second rib has a rounded corner.

4. The optical deflector according to claim 1,
wherein the pair of first protrusions are symmetrical with respect to the first rib, and
the pair of second protrusions are symmetrical with respect to the second rib.

5. The optical deflector according to claim 4,
wherein the intersection and the pair of first protrusions have an elliptical shape as a whole, and the intersection and the pair of second protrusions have an elliptical shape as a whole.

6. The optical deflector according to claim 1,
wherein, in a case where a contour line of one of the pair of first protrusions and a contour line of one of the pair of second protrusions intersect each other, an angle formed by a tangent line of the one of the pair of first protrusions and a tangent line of the one of the pair of second protrusions at a position of intersection is 90° or more.

7. A scanning laser microscope comprising
the optical deflector according to claim 1.
